(19) United States
(12) Patent Application Publication
(10) Pub. No.: US 2023/0406376 A1
(43) Pub. Date: Dec. 21, 2023

(54) CENTRAL APPARATUS AND FAILURE LEVEL CHANGING METHOD

(71) Applicant: Mitsubishi Electric corporation, Chiyoda-ku, Tokyo (JP)

(72) Inventors: Kiyomasa MIWA, Tokyo (JP); Takahiro ITO, Tokyo (JP); Ken SHIBATA, Tokyo (JP)

(73) Assignee: Mitsubishi Electric corporation, Chiyoda-ku, Tokyo (JP)

(21) Appl. No.: 18/044,712

(22) PCT Filed: Sep. 14, 2020
(86) PCT No.: PCT/JP2020/034756

§ 371 Date: Mar. 9, 2023

(51) Int. Cl. B61L 15/00

(52) U.S. Cl. CPC B61L 15/0081; B61L 15/009

(57) ABSTRACT

A central apparatus to be installed on a train, includes: a communication unit that acquires device information indicating a state of a device from the device installed on the train; and a control unit that determines whether to change a failure level to be displayed, with reference to a failure level display definition on the basis of the device information acquired from the device, the failure level display definition defining a condition for changing the failure level indicating a state of a failure of the device to be displayed when the failure of the device is displayed on a display apparatus.

### FIELD

The present disclosure relates to a central apparatus to be installed on a train and a failure level changing method.

### BACKGROUND

In conventional trains, a state of a device installed is monitored, and when a failure of the device is detected, an indicator or the like of a cab is used to show a crew member that the failure of the device has occurred. For example, Patent Literature 1 discloses, as a method for detecting an anomaly of a railroad car, a technique of classifying failures into levels and taking different protective actions according to the failure levels when the failures of devices are detected.

### CITATION LIST

### Patent Literature

Patent Literature 1: Japanese Patent Application Laid-open No. 2018-54567

### SUMMARY

### Technical Problem

However, according to the conventional technique described above, the definition of a failure level is uniquely determined for a failure of the device. That is, a failure level to be displayed does not change even in, for example, a state where a failure frequently occurs or a state where a failure continues. Therefore, the conventional technique described above has a problem in that there are cases where even when a failure of a device is detected, the degree of importance of the failure of the device cannot be appropriately shown to a crew member.

The present disclosure has been made in view of the above, and an object of the present disclosure is to obtain a central apparatus capable of changing a failure level of a device to be displayed, according to circumstances of a failure having occurred in the device.

### Solution to Problem

To solve the problem and achieve the object described above, the present disclosure is a central apparatus to be installed on a train. The central apparatus includes: a communication unit to acquire device information from a device installed on the train, the device information indicating a state of the device; and a control unit to determine whether to change a failure level to be displayed, with reference to a failure level display definition on the basis of the device information acquired from the device, the failure level display definition defining a condition for changing the failure level indicating a state of a failure of the device to be displayed when the failure of the device is displayed on a display apparatus.

### Advantageous Effects of Invention

According to the present disclosure, the central apparatus has the effect of making it possible to change a failure level of a device to be displayed, according to circumstances of a failure having occurred in the device.

### BRIEF DESCRIPTION OF DRAWINGS

FIG. 1 is a diagram illustrating an exemplary configuration of a train control and monitoring system including a central apparatus according to a first embodiment.

FIG. 2 is a flowchart illustrating operation in which the central apparatus according to the first embodiment displays a failure level on a display apparatus.

FIG. 3 is a diagram illustrating an example in which processing circuitry included in the central apparatus according to the first embodiment includes a processor and a memory.

FIG. 4 is a diagram illustrating an example in which the processing circuitry included in the central apparatus according to the first embodiment includes dedicated hardware.

FIG. 5 is a flowchart illustrating operation in which a central apparatus according to a second embodiment displays a failure level on a display apparatus.

FIG. 6 is a diagram illustrating an exemplary configuration of a train control and monitoring system including a central apparatus according to a third embodiment.

FIG. 7 is a flowchart illustrating operation in which a central apparatus according to a fourth embodiment changes a failure level display definition.

FIG. 8 is a flowchart illustrating operation in which a central apparatus according to a fifth embodiment changes a failure level display definition.

### DESCRIPTION OF EMBODIMENTS

Hereinafter, central apparatuses and failure level changing methods according to embodiments of the present disclosure will be described in detail with reference to the drawings.

### First Embodiment

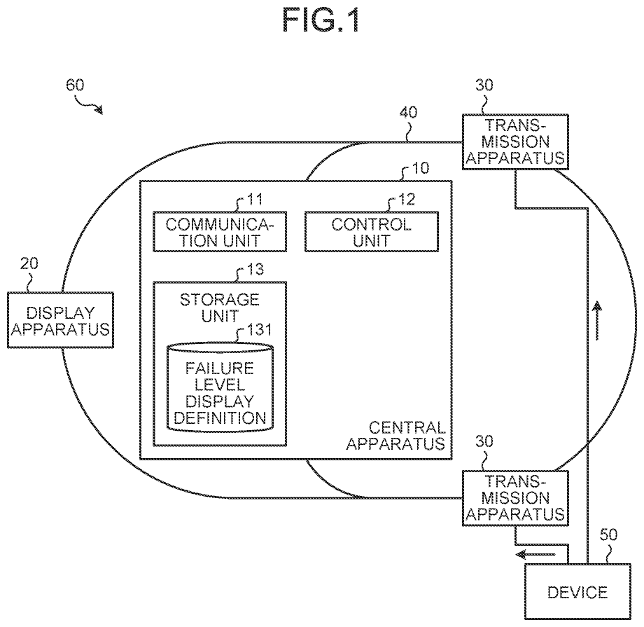

FIG. 1 is a diagram illustrating an exemplary configuration of a train control and monitoring system 60 including a central apparatus 10 according to a first embodiment. The train control and monitoring system 60 is a system to be installed on a train (not illustrated). The train control and monitoring system 60 includes the central apparatus 10, a display apparatus 20, transmission apparatuses 30, a communication network 40, and a device 50.

The central apparatus 10 is installed on the train. The central apparatus 10 monitors and controls the state of the device 50 installed on the train. The central apparatus 10 acquires device information from the device 50 via the transmission apparatuses 30 and the communication network 40. In a case where the device 50 has failed, the central apparatus 10 displays, on the display apparatus 20, information indicating that the failure of the device 50 has been detected and information on a failure level on the basis of the device information. A detailed configuration and operation of the central apparatus 10 will be described below.

The display apparatus 20 displays the state and the like of the device 50 under the control of the central apparatus 10. The display apparatus 20 is assumed to be installed on a cab of a front car or a rear car of the train so that crew members such as a train driver and a conductor can check displayed information. However, the display apparatus 20 may be installed in another place.

The transmission apparatuses 30 relay communication between the device 50 and the central apparatus 10. In the present embodiment, the transmission apparatuses 30 transfer device information transmitted from the device 50 to the central apparatus 10 via the communication network 40. In the example of FIG. 1, a single device 50 is connected to the two transmission apparatuses 30, but two or more devices 50 may be connected to the two transmission apparatuses 30. Furthermore, a communication path from the device 50 to the central apparatus 10 is provided as a duplex system in FIG. 1. However, this is an example, and the configuration of the train control and monitoring system 60 is not limited thereto.

The communication network 40 is a communication network to which the central apparatus 10, the display apparatus 20, the transmission apparatuses 30, and the like are connected, and which serves as communication paths between the apparatuses. A communication system such as Ethernet (registered trademark) can be used for the communication network 40. However, a communication system to be used for the communication network 40 is not limited thereto, and other communication systems may be used for the communication network 40.

The device 50 is installed on the train as described above. The device 50 is, for example, a device essential for operation of the train, such as a door or a brake. In addition, examples of the device 50 also include devices such as a signposting device and an air conditioner. The signposting device is installed on, for example, an upper part of a door in a railroad car, and displays information on a next station, and the like. The air conditioner controls air conditioning in the railroad car. The device 50 transmits device information indicating the state of the device 50 to the central apparatus 10 via the transmission apparatuses 30 and the communication network 40. In the present embodiment, in a case where the device 50 has failed, the device 50 transmits, as the device information, device failure information indicating that the device 50 has failed. In a case where it is conceivable that multiple types of failure may occur in the device 50, the device failure information contains information that can specify details of a failure of the device 50. The device failure information may be a predetermined failure code indicating details of a failure, or may be a message indicating specific details of the failure.

Note that while the train control and monitoring system 60 includes only the single device 50 in the example of FIG. 1 for the sake of simplicity, the train control and monitoring system 60 actually includes a plurality of the devices 50. Furthermore, with regard to the transmission apparatuses 30 connecting the devices 50 and the communication network 40, the present embodiment is based on the assumption that the train control and monitoring system 60 actually includes a plurality of the transmission apparatuses 30 according to the number of the devices 50.

The configuration and operation of the central apparatus 10 will be described. As illustrated in FIG. 1, the central apparatus 10 includes a communication unit 11, a control unit 12, and a storage unit 13.

The communication unit 11 acquires device information indicating the state of the device 50 from the device 50 installed on the train via the transmission apparatuses 30 and the communication network 40. In the present embodiment, the communication unit 11 acquires device failure information as the device information. When the communication unit 11 acquires the device failure information, the communication unit 11 outputs the device failure information to the control unit 12.

The storage unit 13 stores a failure level display definition 131. The failure level display definition 131 is a database in which failure levels are defined according to details of failures of each device 50. The failure level indicates the state of a failure of the device 50 to be displayed when the failure of the device 50 is displayed on the display apparatus 20. The failure level is set for each of one or more possible failure items for each single device 50. For example, five levels of 1 to 5 may be set as the failure levels such that the most significant failure is classified as failure level 1 and the most insignificant failure is classified as failure level 5. However, the setting of the failure levels is not limited thereto. In the following description, a case where the five levels of 1 to 5 are set as the failure levels will be described as an example.

In addition, a condition for changing the failure level at the time of displaying the failure of the device 50 on the display apparatus 20 is defined in the failure level display definition 131. Changing the failure level refers to temporarily raising or lowering a failure level defined in the failure level display definition 131 for a possible failure of a certain device 50. Temporarily raising a failure level refers to, for example, temporarily raising the failure level by “1” for a possible failure item of a certain device 50 in a case where a failure has been detected a set number of times or more within a prescribed period of time. Temporarily lowering a failure level refers to, for example, temporarily lowering the failure level by “1” for a possible failure item of a certain device 50 in a case where a period of time exceeding a prescribed period of time has elapsed since a previous failure was detected or the device 50 started to be used.

The control unit 12 determines whether to change the failure level to be displayed, with reference to the failure level display definition 131 on the basis of the device information acquired from the device 50 via the communication unit 11. In the present embodiment, the device 50 transmits the device failure information as the device information. Therefore, when the control unit 12 acquires the device failure information from the device 50 via the communication unit 11, the control unit 12 determines that the device 50 has failed, and determines whether to change the failure level on the basis of details of the failure of the device 50.

For example, assume that a condition that the failure level is raised when a failure has been detected five times within a prescribed period of time is defined for a certain device 50 in the failure level display definition 131. In this case, when the control unit 12 has acquired the device failure information from the device 50 via the communication unit 11 four times or less within the prescribed period of time, the control unit 12 determines that the failure level should not be changed, and when the control unit 12 has acquired the device failure information from the device 50 via the communication unit 11 five times or more within the prescribed period of time, the control unit 12 determines that the failure level should be raised. Furthermore, as another example, assume that a condition that the failure level is lowered when no failure has been detected for 10 years is defined for a certain device 50 in the failure level display definition 131. In this case, with regard to device failure information acquired from the device 50 via the communication unit 11, in a case where the control unit 12 acquired the previous device failure information of the same type nine years ago, the control unit 12 determines that the failure level should not be changed, and in a case where the control unit 12 acquired the previous device failure information of the same type 11 years ago, the control unit 12 determines that the failure level should be lowered.

Note that the failure level display definition 131 to be stored in the storage unit 13 may be configured in advance such that the content of the failure level display definition 131 differs according to the time that has elapsed since the device 50 started to be used. In general, the failure rate of the device 50 is represented by the trend of a failure rate called a bathtub curve. The bathtub curve is characterized as follows. The probability of an initial failure is high at the initial stage following the beginning of the use of the device 50. After the elapse of the period of time in which an initial failure occurs, the state of the device 50 is stable, and the failure rate due to a random failure stays at a low level. When a period of time in which the device 50 is used exceeds a prescribed period of time, the failure rate increases again due to the influence of wear-out failure or the like. Therefore, the failure level display definition 131 may be configured in advance such that the content of the failure level display definition 131 differs between periods, that is, the initial failure period, the random failure period, and the wear-out failure period.

The control unit 12 transmits information to be displayed on the display apparatus 20 to the display apparatus 20 via the communication unit 11. The communication unit 11 may transmit the information acquired from the control unit 12 to the display apparatus 20 via the communication network 40, or may directly transmit the information to the display apparatus 20 not via the communication network 40. In addition, regarding the information to be displayed on the display apparatus 20, the control unit 12 may generate data to be displayed on a screen (not illustrated) of the display apparatus 20, and transmit the data to the display apparatus 20. Alternatively, the control unit 12 just needs to transmit only control information such as a failure code when the display apparatus 20 includes the failure level display definition 131 as with the central apparatus 10.

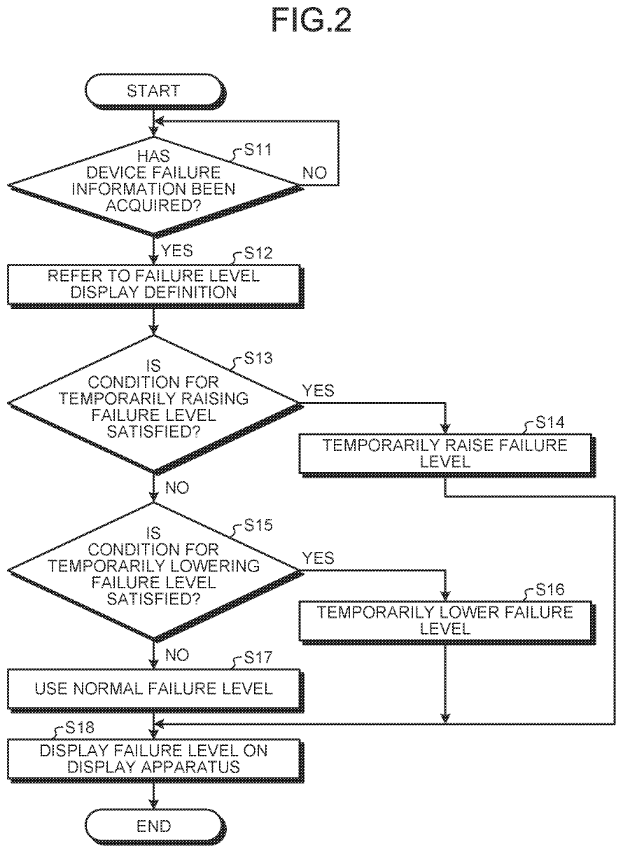

FIG. 2 is a flowchart illustrating operation in which the central apparatus 10 according to the first embodiment displays a failure level on the display apparatus 20. In the central apparatus 10, the communication unit 11 waits until acquiring device failure information via the transmission apparatuses 30 and the communication network 40 (step S11: No). When the communication unit 11 acquires device failure information via the transmission apparatuses 30 and the communication network 40 (step S11: Yes), the communication unit 11 outputs the device failure information to the control unit 12. The control unit 12 refers to the failure level display definition 131 stored in the storage unit 13, on the basis of the device failure information acquired from the communication unit 11 (step S12).

The control unit 12 determines whether a condition for temporarily raising the failure level is satisfied (step S13). When the condition for temporarily raising the failure level is satisfied (step S13: Yes), the control unit 12 determines that the failure level should be temporarily raised (step S14). The control unit 12 refers to the failure level display definition 131, and controls information to be displayed on the display apparatus 20 in such a way as to display a failure level higher than an original failure level set in the failure level display definition 131 for the content of the device failure information acquired this time.

When the condition for temporarily raising the failure level is not satisfied (step S13: No), the control unit 12 determines whether a condition for temporarily lowering the failure level is satisfied (step S15). When the condition for temporarily lowering the failure level is satisfied (step S15: Yes), the control unit 12 determines that the failure level should be temporarily lowered (step S16). The control unit 12 refers to the failure level display definition 131, and controls information to be displayed on the display apparatus 20 in such a way as to display a failure level lower than the original failure level set in the failure level display definition 131 for the content of the device failure information acquired this time.

When the condition for temporarily lowering the failure level is not satisfied (step S15: No), the control unit 12 determines that the failure level should not be changed, that is, the normal failure level defined in the failure level display definition 131 should be used (step S17). The control unit 12 refers to the failure level display definition 131, and controls information to be displayed on the display apparatus 20 in such a way as to display the original failure level set in the failure level display definition 131 for the content of the device failure information acquired this time.

The control unit 12 causes the display apparatus 20 to display the failure level of the device 50 according to any one of the above-described three control approaches (step S18). Note that steps S13 and S15 may be performed by the control unit 12 in reverse order.

Next, a hardware configuration of the central apparatus 10 will be described. In the central apparatus 10, the communication unit 11 is an interface such as a communication apparatus. The storage unit 13 is a memory. The control unit 12 is implemented by processing circuitry. The processing circuitry may be a memory and a processor that executes programs stored in the memory, or may be dedicated hardware.

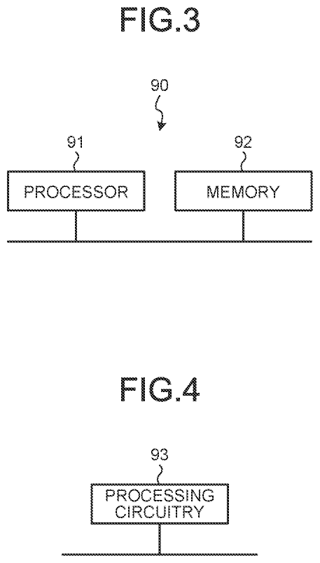

FIG. 3 is a diagram illustrating an example in which processing circuitry 90 included in the central apparatus 10 according to the first embodiment includes a processor 91 and a memory 92. In a case where the processing circuitry 90 includes the processor 91 and the memory 92, each function of the processing circuitry 90 of the central apparatus 10 is implemented by software, firmware, or a combination of software and firmware. The software or firmware is described as a program, and stored in the memory 92. The processor 91 reads and executes the program stored in the memory 92 to implement each function of the processing circuitry 90. That is, the processing circuitry 90 includes the memory 92 for storing programs that result in execution of the processing of the central apparatus 10. Furthermore, it can also be said that these programs cause a computer to execute a procedure and a method for the central apparatus 10.

Here, the processor 91 may be a central processing unit (CPU), a processing device, an arithmetic device, a microprocessor, a microcomputer, a digital signal processor (DSP), or the like. Furthermore, examples of the memory 92 include nonvolatile or volatile semiconductor memories such as a random access memory (RAM), a read only memory (ROM), a flash memory, an erasable programmable ROM (EPROM), and an electrically EPROM (EEPROM) (registered trademark), a magnetic disk, a flexible disk, an optical disk, a compact disk, a mini disk, and a digital versatile disc (DVD).

FIG. 4 is a diagram illustrating an example in which processing circuitry 93 included in the central apparatus 10 according to the first embodiment includes dedicated hardware. In a case where the processing circuitry 93 includes dedicated hardware, examples of the processing circuitry 93 illustrated in FIG. 4 include a single circuit, a composite circuit, a programmed processor, a parallel-programmed processor, an application specific integrated circuit (ASIC), a field programmable gate array (FPGA), and a combination thereof. The functions of the central apparatus 10 may be separately implemented by the processing circuitry 93, or may be collectively implemented by the processing circuitry 93.

Note that some of the functions of the central apparatus 10 may be implemented by dedicated hardware, and some of the other functions thereof may be implemented by software or firmware. Thus, the processing circuitry can implement each of the above-described functions by means of dedicated hardware, software, firmware, or a combination thereof.

As described above, according to the present embodiment, the central apparatus 10 determines whether to temporarily change the failure level, with reference to the failure level display definition 131 on the basis of device failure information acquired from the device 50. As a result, for example, in a state where a failure frequently occurs in a certain device 50, or in a state where a failure continuously occurs in the certain device 50, the central apparatus 10 can temporarily raise a failure level and display the raised failure level. Furthermore, for example, in a case where no failure has been detected in a certain device 50 within a prescribed period of time, the central apparatus 10 can temporarily lower a failure level and display the lowered failure level.

### Second Embodiment

In the first embodiment, the device 50 determines whether the device 50 has failed, and transmits device failure information when determining that the device 50 has failed. In a second embodiment, a case where the central apparatus 10 determines whether the device 50 has failed will be described.

In the second embodiment, the configuration of the train control and monitoring system 60 is similar to the configuration of the train control and monitoring system 60 in the first embodiment illustrated in FIG. 1. In the second embodiment, the device 50 transmits device information including a measurement value to the central apparatus 10 via the transmission apparatuses 30 and the communication network 40. The measurement value is obtained by measurement of an operation state of the device 50. In a case where the device 50 includes a motor, examples of the measurement value include a current flowing through the motor and a voltage applied to the motor. In a case where the device 50 includes a compressor, examples of the measurement value include a pressure in the compressor. The measurement value may be a temperature or the like in a railroad car in a case where the device 50 is an air conditioner. The measurement value may be measured by the device 50 itself, or may be measured by a sensor (not illustrated) installed in the device 50.

In the central apparatus 10, the communication unit 11 acquires the device information transmitted from the device 50 via the transmission apparatuses 30 and the communication network 40. The communication unit 11 outputs the acquired device information to the control unit 12. When the control unit 12 acquires the device information via the communication unit 11, the control unit 12 determines whether the device 50 has failed, on the basis of the measurement value included in the device information. For example, the central apparatus 10 stores, in the storage unit 13, a threshold value for a measurement item corresponding to the measurement value in the device information transmitted from the device 50. The threshold value enables determination as to whether a failure has occurred. The control unit 12 determines whether the device 50 has failed, by using the measurement value included in the device information and the threshold value.

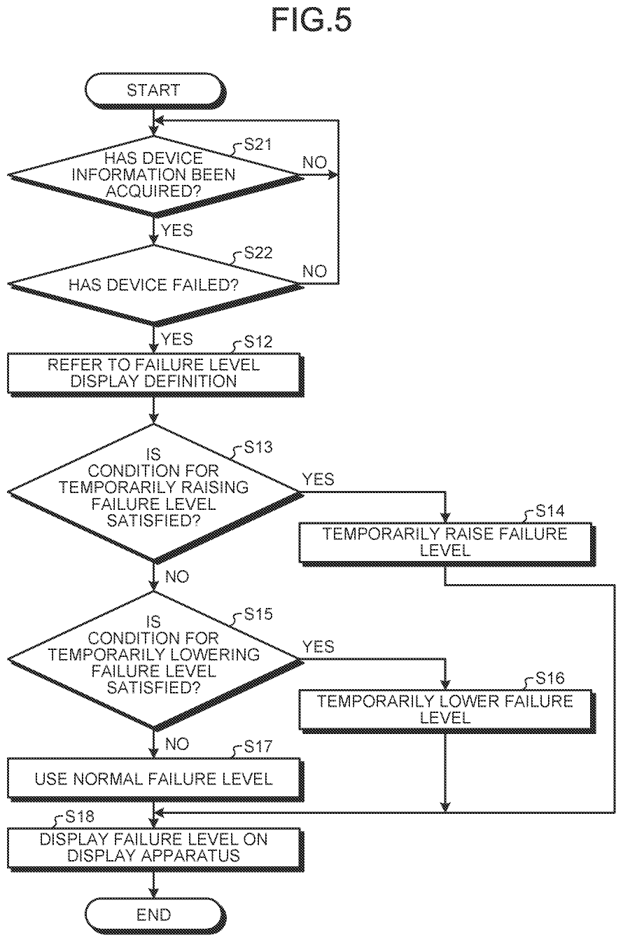

FIG. 5 is a flowchart illustrating operation in which the central apparatus 10 according to the second embodiment displays a failure level on the display apparatus 20. In the central apparatus 10, the communication unit 11 waits until acquiring device information via the transmission apparatuses 30 and the communication network 40 (step S21: No). When the communication unit 11 acquires device information via the transmission apparatuses 30 and the communication network 40 (step S21: Yes), the communication unit 11 outputs the device information to the control unit 12. As described above, the control unit 12 determines whether the device 50 has failed, on the basis of a measurement value included in the device information (step S22). When the device 50 has not failed (step S22: No), the central apparatus 10 returns to step S21, and repeats the above-described operation. When the device 50 has failed (step S22: Yes), the control unit 12 refers to the failure level display definition 131 stored in the storage unit 13 on the basis of details of the failure of the device 50 (step S12). Operation to be performed in steps S12 to S18 is similar to that in the first embodiment.

As described above, according to the present embodiment, the central apparatus 10 determines whether the device 50 has failed, on the basis of the device information acquired from the device 50. Also in this case, the central apparatus 10 can obtain the effect similar to that in the first embodiment.

### Third Embodiment

In the first embodiment and the second embodiment, the central apparatus 10 stores the failure level display definition 131. In a third embodiment, a ground system installed on the ground stores the failure level display definition 131. The third embodiment can be applied to the first embodiment and the second embodiment. Here, application of the third embodiment to the first embodiment will be described as an example.

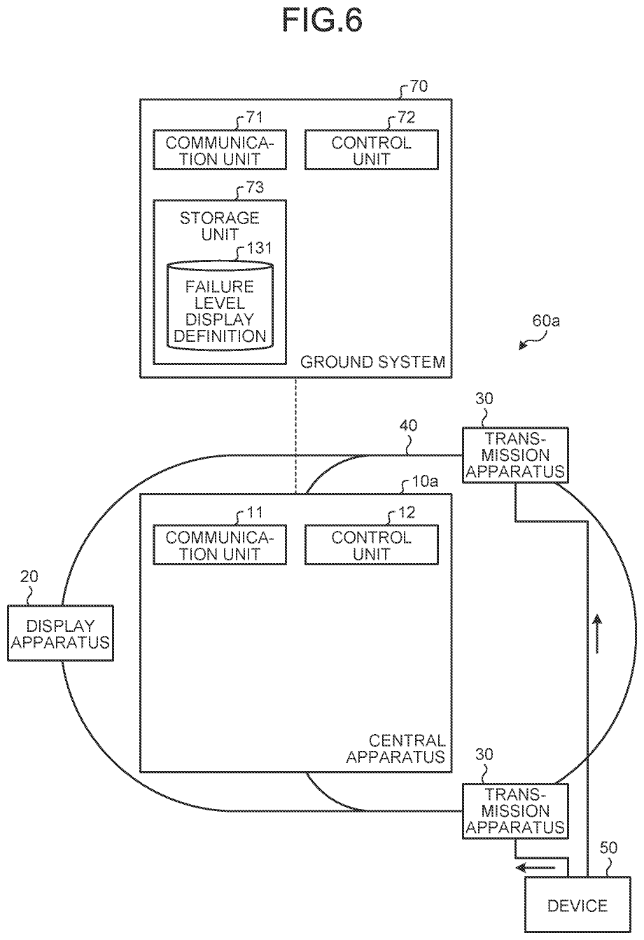

FIG. 6 is a diagram illustrating an exemplary configuration of a train control and monitoring system 60a including a central apparatus 10a according to the third embodiment. The train control and monitoring system 60a performs wireless communication with a ground system 70 installed on the ground. The train control and monitoring system 60a is obtained by replacing the central apparatus 10 in the train control and monitoring system 60 of the first embodiment illustrated in FIG. 1 with the central apparatus 10a. The central apparatus 10a differs from the central apparatus 10 in not including the storage unit 13, that is, not storing the failure level display definition 131.

The ground system 70 is a system that manages operation of a train (not illustrated) equipped with the train control and monitoring system 60a. The ground system 70 includes a communication unit 71, a control unit 72, and a storage unit 73. The communication unit 71 communicates with the communication unit 11 of the central apparatus 10a. The storage unit 73 stores the failure level display definition 131. The failure level display definition 131 stored in the storage unit 73 is similar to the failure level display definition 131 stored in the storage unit 13 of the central apparatus 10 in the first embodiment and the second embodiment. For example, in response to a reference request from the central apparatus 10a, the control unit 72 reads corresponding information from the failure level display definition 131 stored in the storage unit 73. Note that communication between the communication unit 71 of the ground system 70 and the communication unit 11 of the central apparatus 10a may be relayed by another communication apparatus or the like.

Operation of the central apparatus 10a is similar to the operation in the flowchart of the first embodiment illustrated in FIG. 2. In the third embodiment, when referring to the failure level display definition 131 in step S12, the control unit 12 refers to the failure level display definition 131 stored in the storage unit 73 of the ground system 70 via the communication unit 11 and the communication unit 71 of the ground system 70. In this manner, in a case where the ground system 70 stores the failure level display definition 131, the control unit 12 can refer to the failure level display definition 131 stored in the ground system 70 via the communication unit 11.

As described above, according to the present embodiment, the ground system 70 capable of communicating with the central apparatus 10a stores the failure level display definition 131. As a result, an administrator of the ground system 70 can more easily set the failure level display definition 131 or change the content thereof than in a case where the central apparatus 10 of each train stores the failure level display definition 131.

### Fourth Embodiment

In a fourth embodiment, a case where the content of the failure level display definition 131 is changed will be described. The fourth embodiment can be applied to the first to third embodiments. Here, application of the fourth embodiment to the first embodiment will be described as an example.

In the central apparatus 10, the control unit 12 acquires device failure information from the device 50 via the communication unit 11. Meanwhile, it is conceivable that device failure information may be acquired from a certain device 50 in a specific acquisition pattern. In such a case, the control unit 12 may change the content of the failure level display definition 131 on the basis of the specific acquisition pattern. For example, in a case where past cases show that the frequency of failures of a certain device 50 tends to rapidly increase when a certain period of time has elapsed since the certain device 50 started to be used, the control unit 12 may change the content of the failure level display definition 131 according to a period of time that has elapsed since the certain device 50 started to be used. In addition, assume a case where a pattern in which device failure information has been acquired thus far indicates that there is no sign of failure in terms of operation of a certain device 50 for a while after a failure occurred in the certain device 50, that is, device failure information on the certain device 50 was first acquired, and that operation of the certain device 50 shows a sign of failure after a prescribed period of time has elapsed since the device failure information was first acquired. In such a case, the control unit 12 may change a failure level to be displayed, that is, the content of the failure level display definition 131 according to a period of time that has elapsed since the device failure information was first acquired. The phrase “after a prescribed period of time has elapsed since the device failure information was first acquired” may be replaced with, for example, “after the device failure information has been acquired a prescribed number of times since the device failure information was first acquired”.

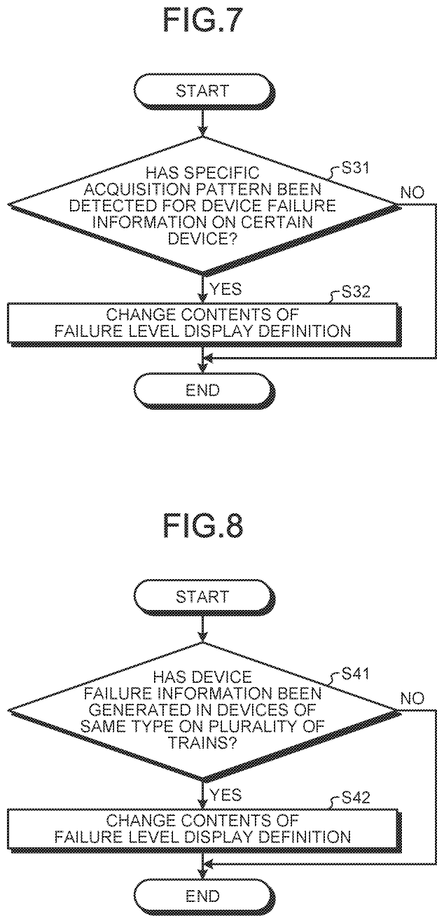

FIG. 7 is a flowchart illustrating operation in which the central apparatus 10 according to the fourth embodiment changes the failure level display definition 131. In a case where a specific acquisition pattern can be detected for device failure information on a certain device 50 from a pattern in which device failure information has been acquired thus far (step S31: Yes), the control unit 12 changes the content of the failure level display definition 131 stored in the storage unit 13 on the basis of the detected specific acquisition pattern (step S32). When no specific acquisition pattern can be detected for the certain device 50 from the pattern in which device failure information has been acquired thus far (step S31: No), the control unit 12 ends the operation of changing the failure level display definition 131.

In this manner, the control unit 12 of the central apparatus 10 can change the failure level display definition 131 stored in the storage unit 13 on the basis of circumstances of a failure having occurred in the device 50 installed on a train. Note that a case where the control unit 12 of the central apparatus 10 changes the failure level display definition 131 stored in the storage unit 13 has been described here, but the method for changing the failure level display definition 131 is not limited thereto. For example, when a specific acquisition pattern is detected for a certain device 50 from a pattern in which device failure information has been acquired thus far, a crew member, an administrator of the ground system 70, or the like may manually change the failure level display definition 131 stored in the storage unit 13. In addition, in the second embodiment, the control unit 12 can obtain an effect similar to that described above by performing the above-described operation only for device information based on which the control unit 12 has determined that the device 50 has failed.

Furthermore, in the third embodiment, the control unit 72 of the ground system 70 may change the failure level display definition 131 stored in the storage unit 73 by performing operation similar to the operation of the control unit 12 of the central apparatus 10. In this manner, the ground system 70 can change the failure level display definition 131 stored in the storage unit 73 on the basis of circumstances of a failure having occurred in the device 50 installed on a specific train. Note that when a specific acquisition pattern is detected for a certain device 50 from a pattern in which device failure information has been acquired thus far, a crew member of a train, the administrator of the ground system 70, or the like may manually change the failure level display definition 131 stored in the storage unit 73 included in the ground system 70.

As described above, according to the present embodiment, when a specific acquisition pattern for acquisition of device failure information on a certain device 50 is detected, the central apparatus 10 may change the content of the failure level display definition 131 stored in the storage unit 13. As a result, since the central apparatus 10 can change the failure level display definition 131 stored in the storage unit 13 on the basis of the actual state of the device 50 and the state of failure, the central apparatus 10 can accurately display a failure level when the failure of the device 50 is detected.

### Fifth Embodiment

In a fifth embodiment, a case where the content of the failure level display definition 131 is changed by use of device information generated on another train will be described. The fifth embodiment can be applied to the first to third embodiments. Here, application of the fifth embodiment to the first embodiment will be described as an example.

In general, the number of trains traveling on a certain route is not just one, but a plurality of trains travel. In this case, it is conceivable that each train may be equipped in a similar manner and travel on the route under similar traveling conditions. Therefore, when a failure occurs in a certain device 50 on a certain train, it is conceivable that a failure will also occur in the same type of device 50 on another train being used under similar use conditions. Therefore, the control unit 12 of the central apparatus 10 cooperates with the control unit 12 of the central apparatus 10 installed on another train, and changes the content of the failure level display definition 131 on the basis of a failure of the device 50 that has occurred in the another train, that is, device information. In order to omit a failure of the device 50 that has occurred unexpectedly, the control unit 12 of the central apparatus 10 changes the content of the failure level display definition 131 on the basis of, for example, failures of the devices 50 of the same type having occurred on a plurality of trains including the own train, that is, device information.

FIG. 8 is a flowchart illustrating operation in which the central apparatus 10 according to the fifth embodiment changes the failure level display definition 131. When failures have occurred, that is, device failure information has been generated in the devices 50 of the same type on a plurality of trains (step S41: Yes), the control unit 12 changes the content of the failure level display definition 131 stored in the storage unit 13 for the corresponding device 50 in cooperation with the control units 12 of the central apparatuses 10 of other trains (step S42). When no failure has occurred, that is, no device failure information has been generated in the devices 50 of the same type on the plurality of trains (step S41: No), the control unit 12 ends the operation of changing the failure level display definition 131.

In this manner, the control unit 12 of the central apparatus 10 can change the failure level display definition 131 stored in the storage unit 13 on the basis of circumstances of failures having occurred in the devices installed on a plurality of trains. Note that a case where the control unit 12 of the central apparatus 10 changes the failure level display definition 131 stored in the storage unit 13 has been described here, but the method for changing the failure level display definition 131 is not limited thereto. For example, when detecting that similar failures have occurred in the devices 50 of a certain type on a plurality of trains from device failure information on the plurality of trains, a crew member, an administrator of the ground system 70, or the like may manually change the failure level display definition 131 stored in the storage unit 13.

In addition, in the second embodiment, the control unit 12 can obtain the effect similar to that described above by performing the above-described operation only for device information based on which the control unit 12 has determined that the device 50 has failed.

Furthermore, in the third embodiment, the control unit 72 of the ground system 70 may change the failure level display definition 131 stored in the storage unit 73 by performing operation similar to the operation of the control unit 12 of the central apparatus 10. In this manner, the ground system 70 can change the failure level display definition 131 stored in the storage unit 73 on the basis of circumstances of failures having occurred in the devices 50 installed on a plurality of trains. Note that, when detecting that similar failures have occurred in the devices 50 of a certain type on a plurality of trains from device failure information on the plurality of trains, a crew member, the administrator of the ground system 70, or the like may manually change the failure level display definition 131 stored in the storage unit 73 included in the ground system 70.

As described above, according to the present embodiment, the central apparatus 10 may change the content of the failure level display definition 131 in a case where failures have occurred in the devices 50 of the same type on a plurality of trains. As a result, since the central apparatus 10 can change the failure level display definition 131 on the basis of the actual states of the devices 50 and the states of failures, the central apparatus 10 can accurately display a failure level when a failure of the device 50 is detected. In addition, the central apparatus 10 can change the content of the failure level display definition 131 on the basis of device failure information acquired by a plurality of trains. This is also applicable to condition-based maintenance (CBM), that is, failure prediction.

The configurations set forth in the above embodiments show examples, and it is possible to combine the configurations with another known technique or combine the embodiments with each other, and is also possible to partially omit or change the configurations without departing from the scope of the present disclosure.

### REFERENCE SIGNS LIST

10, 10a central apparatus; 11, 71 communication unit; 12, 72 control unit; 13, 73 storage unit; 20 display apparatus; 30 transmission apparatus; 40 communication network; 50 device; 60, 60a train control and monitoring system; 70 ground system; 131 failure level display definition.

1. A central apparatus comprising:
communication circuitry to acquire device information from a device installed on the train, the device information indicating a state of the device; and
control circuitry to determine whether to change a failure level to be displayed, with reference to a failure level display definition on the basis of the device information acquired from the device, the failure level display definition defining a condition for changing the failure level indicating a state of a failure of the device to be displayed when the failure of the device is displayed on a display apparatus, wherein
changing the failure level refers to temporarily raising or lowering a failure level defined in the failure level display definition for a possible failure of the device.

2. The central apparatus according to claim 1, comprising:
memory to store the failure level display definition, wherein
the control circuitry refers to the failure level display definition stored in the memory.

3. The central apparatus according to claim 2, wherein
the control circuitry is capable of changing the failure level display definition on the basis of circumstances of a failure occurred in the device.

4. The central apparatus according to claim 1, wherein
a ground system stores the failure level display definition, and
the control circuitry refers to the failure level display definition stored in the ground system, via the communication circuitry.

5. The central apparatus according to claim 4, wherein
the ground system is capable of changing the failure level display definition on the basis of circumstances of a failure occurred in the device.

6. The central apparatus according to claim 1, wherein
the device transmits, as the device information, device failure information indicating that the device fails, and
when the control circuitry acquires the device failure information via the communication circuitry, the control circuitry determines that the device fails.

7. The central apparatus according to claim 1, wherein
the device transmits device information including a measurement value obtained by measurement of an operation state of the device, and
when the control circuitry acquires the device information via the communication circuitry, the control circuitry determines whether the device fails on the basis of the measurement value included in the device information.

8. The central apparatus according to claim 1, wherein
a content of the failure level display definition differs according to time that elapses after the device starts to be used.

9. A failure level changing method comprising:
acquiring device information from a device installed on a train by communication circuitry, the device information indicating a state of the device; and
determining whether to change a failure level to be displayed, with reference to a failure level display definition on the basis of the device information acquired from the device, by control circuitry, the failure level display definition defining a condition for changing the failure level indicating a state of a failure of the device to be displayed when the failure of the device is displayed on a display apparatus wherein
changing the failure level refers to temporarily raising or lowering a failure level defined in the failure level display definition for a possible failure of the device.

10. The failure level changing method according to claim 9, wherein
a central apparatus includes a memory to store the failure level display definition, and
in the determining, the control circuitry refers to the failure level display definition stored in the memory.

11. The failure level changing method according to claim 10, wherein
in the determining, the control circuitry is capable of changing the failure level display definition on the basis of circumstances of a failure occurred in the device.

12. The failure level changing method according to claim 9, wherein
a ground system stores the failure level display definition, and
in the determining, the control circuitry refers to the failure level display definition stored in the ground system, via the communication circuitry.

13. The failure level changing method according to claim 12, wherein
the ground system is capable of changing the failure level display definition on the basis of circumstances of a failure occurred in the device.

14. The failure level changing method according to claim 9, wherein
the device transmits, as the device information, device failure information indicating that the device fails, and
in the determining, when the device failure information is acquired via the communication circuitry, the control circuitry determines that the device fails.

15. The failure level changing method according claim 9, wherein
the device transmits device information including a measurement value obtained by measurement of an operation state of the device, and
in the determining, when the device information is acquired via the communication circuitry, the control circuitry determines whether the device fails on the basis of the measurement value included in the device information.

16. The failure level changing method according to claim 9, wherein
a content of the failure level display definition differs according to time that elapses after the device starts to be used.
